(19) United States
(12) Patent Application Publication
(10) Pub. No.: US 2022/0136435 A1
(43) Pub. Date: May 5, 2022

(54) ENTRAINMENT COMPRESSION SYSTEM FOR JET ENGINE

(71) Applicant: LARRY BURFORD, DALLAS, TX (US)

(72) Inventor: LARRY BURFORD, DALLAS, TX (US)

(21) Appl. No.: 17/085,922

(22) Filed: Oct. 30, 2020

(51) Int. Cl. F02C 3/34; F04C 29/12; F02K 3/11

(52) U.S. Cl. CPC F02C 3/34; F05D 2220/323; F02K 3/11; F04C 29/124

(57) ABSTRACT

A jet engine uses an entrainment compressor within a housing to compress intake air. The compressed air is routed to a combustion chamber where it is ignited. A portion of the exhaust is directed outward for thrust and a portion is rerouted through an energy feedback system to one or more entrainment nozzles within the compressor housing. The exhaust acts as motive fluid to mix with the intake air. The motive fluid imparts energy to create the compressive capability of the jet engine. A startup system is configured to generate startup motive fluid selectively routed through some or all of the entrainment nozzles to initiate a stable idle flow of motive fluid. Some of the entrainment nozzles may include combustion chambers to further enhance the compressive capability of the jet engine.

### BACKGROUND OF THE INVENTION

### 1. Field of the Invention

The present application relates to an improved jet engine, and more particularly to a jet engine using entrainment compressors.

### 2. Description of Related Art

Jet engines are an example of the internal combustion category of heat engines. Such engines all have some means to pull in and compress ambient air, and a further means to add fuel to the compressed air and burn it, and one or more additional means to process the combustion energy. Some internal combustion engines burn their fuel in an intermittent process (e.g. the piston engine), while others burn it in a continuous process (e.g. the jet engine). The most common jet engine now is the turbojet and its variants.

The several mechanisms of all internal combustion engines are designed to capture a portion of the energy (thermal/pressure/velocity and so on) generated in the combustion processes and feed it back to the part of the engine that processes the incoming air stream. This energy is converted by various machine dependent methods into a form that can be added back to the incoming air stream to compress it and thus continuing the overall process. The remaining energy from combustion not used to maintain the combustion process is then converted by other machine dependent methods into a form that can do useful work.

Of particular relevance to this invention are three existing devices. Variants of two of them (the turbojet engine and the thermo-compressor) are used widely today in various industries. Turbojets have been around for almost a century, and thermo-compressors, a type of entrainment compressor, have been around for more than a century. The third device is also a variant of the entrainment compressor. It uses air rather than steam as both the motive fluid and the working fluid, and is sometimes referred to as an air-jet compressor, or an air-jet pump.

The first important device is known as the turbojet engine. It and numerous variants are being used by many companies, primarily in the power generation and transportation industries.

Referring now to FIGS. 1A-1C in the drawings, a conventional view of a turbojet engine is illustrated. The simplified diagram of FIG. 1A shows the major subsystems of a turbojet engine and their relationship to each other. This diagram depicts a seven stage compressor and a four stage turbine. The precise number of stages in each is adjustable.

FIG. 1B shows two consecutive intake compressor stages, each comprising one set of rotating blades paired with one set of stationary vanes. The stationary vanes are downwind of the rotating blades and redirect the air flow going to the next stage to improve efficiency/energy-transfer.

FIG. 1C shows two consecutive exhaust turbine stages, each also comprising one set of rotating blades paired with one set of stationary vanes. The stationary vanes are upwind of the rotating blades and also redirect the exhaust gas flow going to the next rotor to improve efficiency/energy transfer.

These two subsystems are very similar in construction but do essentially opposite jobs. The turbine's job is to subtract energy from the exhaust flow after combustion has heated it greatly. The energy extracted by the turbine is transferred to the turbo-compressor at the front of the engine by a drive shaft connecting the turbine and the compressor. The compressor's job is to add this energy to large quantities of air, compressing it and forcing it into the combustion chambers where fuel is added and burned. The hot exhaust gasses then blow through the turbine and the energy feedback cycle is completed. The portion of the exhaust gas energy not subtracted for compressing intake air passes out via the exhaust nozzle at high velocity and provides copious amounts of thrust.

A typical turbojet engine is capable of processing a ton of air per second. Processing, in this context, means compressing that air to somewhere between 20 and 40 atmospheres, depending mostly on the customer's performance requirements. Each compression stage of the typical turbo compressor will increase the pressure by about 10 to 30 percent. Much higher per-stage compression ratios are possible, but in real-world machines problems like compressor stall are greatly reduced by spreading the compression task over more stages.

The second important prior art device is a compression system known as a thermo compressor and has been in use for over a century in various manufacturing and refining operations. It can be used as a compressor or a pump and is based on the physical phenomenon of entrainment. Thermo compressors are used primarily to extract and recycle unused energy from steam. Thermo-compressors use steam as both the motive fluid and the working fluid. They are sometimes referred to as a steam-jet compressor.

The third important prior art device is an entrainment compression device used in an experimental lift augmentation system. It is sometimes known as an air-jet entrainment compressor. This system has been explored from available research and does not appear to be in use anywhere today. Until recently, the only performance data related to entrainment compression devices available was for the thermo-compressor variant discussed above. Physical test data from this device demonstrated that large mass entrainment ratios (on order of 30:1 or better) were possible, especially when compression ratios were kept low. This third device was built and tested as a way to create lift by sucking ambient air (the working fluid) from above certain wing surfaces and then blowing ambient air (still the working fluid) over certain wing flaps. Both actions will create a low pressure area above portions of the wing surface.

Although strides have been made, shortcomings remain. It is desired that the turbo-jet's complicated, heavy and expensive rotating compressor and energy feedback systems be replaced with the simpler, lighter and less expensive non-rotating compressor and energy feedback systems as detailed herein.

### BRIEF SUMMARY OF THE INVENTION

It is an object of the present application to provide a jet engine system that incorporates entrainment compression as a physical process by replacing a number of rotating components with non-rotating components. In particular, rotating parts such as the turbo compressor, exhaust turbine, and corresponding drive shaft are removed. These are replaced with an entrainment compressor and energy feedback system comprising a tubing and valve network.

This system provides an improved method for implementing an energy/power feedback function by redirecting a portion of the exhaust gas (now being labeled motive fluid) after combustion via a tubing and valve network to a plurality of nozzles located within a housing that is typically tapered (the entrainment compressor system) prior to the combustion chamber. The motive and working fluid then combine and compress inside the entrainment compressor to complete the improvement. The jet engine of the present application is simplified with minimal to no rotating parts. This novel jet engine system can produce thrust ranging from idle power to full takeoff power at any airspeed ranging from vehicle-zero to vehicle-maximum.

Ultimately the invention may take many embodiments. In these ways, the present invention overcomes the disadvantages inherent in the prior art. The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions insofar as they do not depart from the spirit and scope of the present application.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1A is a side view of a turbo-jet engine.

FIG. 1B is an enlarged side view of two consecutive compressor stages and the airflow through them in a compressor of the jet engine of FIG. 1A.

FIG. 1C is an enlarged side view of two consecutive turbine stages and the exhaust gas flow through them in a turbine of the jet engine of FIG. 1A.

FIG. 2 is a chart of an entrainment compressed jet engine system according to an embodiment of the present application.

FIG. 3 is a side view of an exemplary embodiment of the entrainment compressed jet engine system of FIG. 2.

FIG. 4 is a front view of an entrainment compressor system in the entrainment compressed jet engine system of FIG. 3.

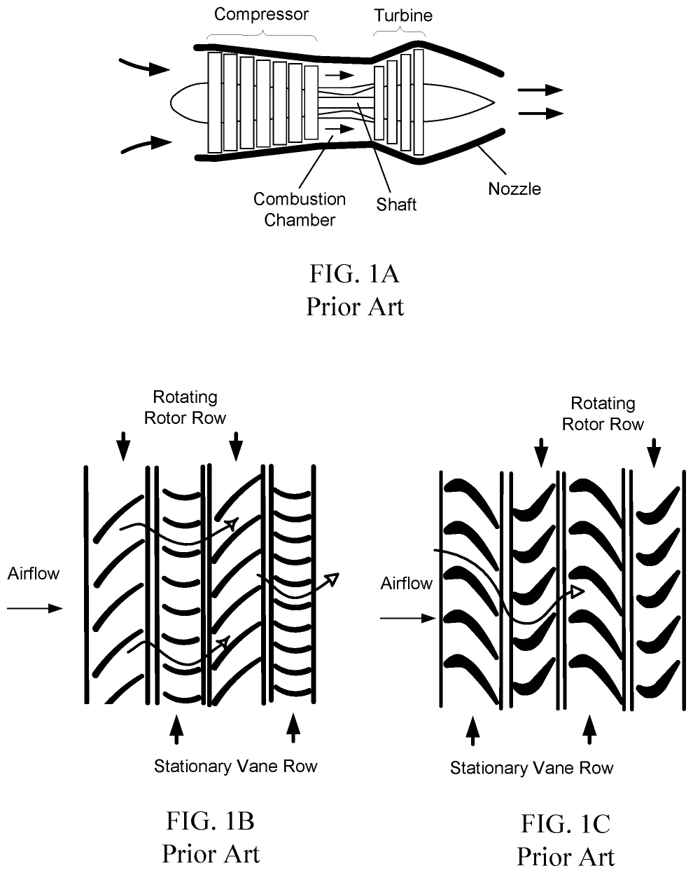

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE INVENTION

Illustrative embodiments of a preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The embodiments and method in accordance with the present application overcomes one or more of the above-discussed problems commonly associated with the prior art discussed previously. In particular, the jet engine of the present application uses an entrainment compressor to compress intake air. The compressed air is routed to a combustion chamber where it is ignited. A portion of the exhaust is directed outward for thrust and a portion is rerouted through an energy feedback system to one or more nozzles within the compressor housing. The redirected portion of the exhaust acts as motive fluid to mix with the intake air. This motive fluid imparts energy to the intake air via the entrainment effect to compress the air prior to conveying it to the combustion chamber. These and other unique features are discussed below and illustrated in the accompanying drawings.

The embodiments and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

The embodiments and method of the present application is illustrated in the associated drawings. The jet engine of the present application uses an entrainment compressor which forces high pressure air into the combustion chamber, where fuel is added and burned. Most of the exhaust gasses escape via an exhaust nozzle to produce thrust, but a selectable portion is extracted and conveyed to the entrainment compressor by the energy feedback system. This energy feedback system is an array of tubes and valves that guides a certain amount of exhaust gas (the motive fluid) to each of the several nozzles in the compressor subsystem.

When these gasses exit the many nozzles inside the compressor subsystem, ambient air (the working fluid) is sucked into the compressor and progressively compressed as it passes beyond various nozzles and finally is forced into the combustion chamber. This therefore completes the cycle. The system is configured to operate without the need of rotating and stationary vanes for a compressor or turbine, nor the need for a shaft. Additional features and functions are illustrated and discussed below.

Entrainment is the physical process wherein a fast flowing (motive) fluid (i.e. exhaust gases) is introduced into a relatively slow flowing or stationary fluid (the working fluid or intake air). As the two fluids mix together energy is transferred from the motive fluid to the working fluid via turbulence and/or friction and/or other processes. The resultant mixed (product) fluid is of intermediate energy content (temperature/pressure and so on). The product fluid exits the mixing area and moves out into the larger environment.

Parts such as duct work or tubing are normally used to contain and direct the entrainment process, enhancing the usefulness of the energy transfers involved. Certain shapes for these parts have been discovered to further enhance the usefulness of the energy transfers associated with the entrainment process. However, entrainment at some level will always happen, without any ‘equipment’ being involved, whenever a ‘fast’ fluid enters a ‘slow’ fluid.

Referring now to the Figures wherein like reference characters identify corresponding or similar elements in form and function throughout the several views. The following Figures describe embodiments of the present application and its associated features. With reference now to the Figures, embodiments of the present application are herein described. It should be noted that the articles “a”, “an”, and “the”, as used in this specification, include plural referents unless the content clearly dictates otherwise.

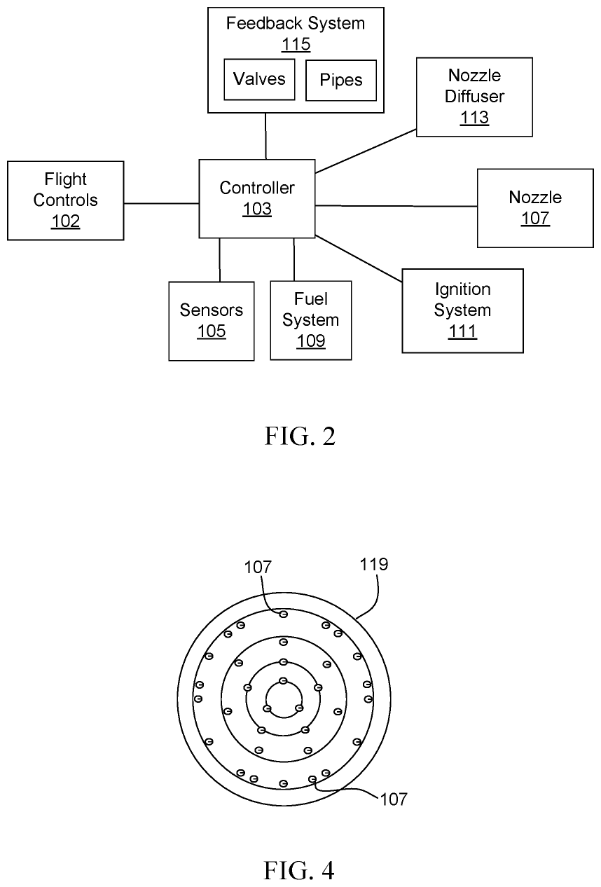

Referring now to FIG. 2 in the drawings, a chart of the jet engine system of the present application is illustrated. Jet engine system 101 includes a controller 103 in communication with one or more flight controls 102. Controller 103 is configured to regulate operation of system 101 from initial startup, through idling, into acceleration and deceleration, and within cruising speeds. Controller 103 is configured to be in communication with one or more sensors 105 located throughout system 101. The sensors 105 gather performance data from various sections of the system and relay particular data to the controller for processing. The controller is configured to selectively transmit one or more data outputs to the components, systems, devices, and/or subsystems within system 101 to control performance. Controller 103 is a computerized device having one or more processors, a database for storage of data, and an input/output interface for the accessing and maintenance of controller 103 and system 101. In operation, a user would request selected actions through flight controls 102 which are communicated to controller 103. Controller 103 then analyzes system 101 and initiates the appropriate data outputs to carry out the desired actions.

A plurality of devices, systems, and sensors operate together to provide a functioning jet engine. The engine includes an entrainment compressor system that contains a plurality of nozzles 107. Nozzles 107 receive motive fluid (redirected exhaust gas) through feedback system 115 to mix with fresh intake air. The entrainment compressor system directs fresh intake air through an inlet 121 into a housing where it is compressed into a combustion chamber. A fuel system 109 selectively disperses fuel into the combustion chamber to ignite with the compressed air. An ignition system 111 is used to assist with startup functions of system 101 among other things. The exhaust is partially directed out through exhaust nozzle 113 for the generation of thrust.

Referring now also to FIG. 3 in the drawings, a side view of an exemplary embodiment of entrainment jet engine system 101 is illustrated. FIG. 3 illustrates a simplified depiction of one embodiment of this invention. System 101 illustrates an entrainment compressor system 117 comprised of a hollowed housing 119 that is typically tapered and containing a plurality of nozzles 107. Motive fluid/exhaust gas exits the nozzles 107 and mixes with fresh air/working fluid that enters through inlet 121. As the air moves through housing 119, it compresses. As noted, there is no need to have conventional rotating vanes to mechanically compress the working fluid. The introduction of motive fluid imparts energy via the entrainment process rather than rotation to the working fluid to induce a compressive effect.

For entrainment compressor system 117 to operate, motive fluid is typically routed back from the combustion chamber 123 (the highest energy location in the system 101) but can, in part or entirely, be routed back from earlier points in the compression system 117 which can have a higher pressure. Motive fluid is passed through Energy feedback system 115 via a plurality of tubes and pipes. One or more valves are located throughout the tubing to permit controller 103 to selectively regulate the amount and source of motive fluid reaching the nozzles 107.

The compressor system 117 comprises six compressor stages 118. A real entrainment compressed jet engine, much like a real turbojet engine, might have as many as two dozen compression stages, depending on the customer's performance requirements among other things. The precise number of stages 118 is determinable based upon engineering constraints but may be one or more in number. Nozzles 107 are organized into arrays, typically circular, and these arrays would usually be located sequentially from the compressor inlet to the compressor outlet, adjacent combustion chamber 123.

Each of these nozzle arrays (compressor stages 118) provides a portion of the total compression needed for the engine to function. The air compressed by the first stage moves down the duct toward the combustion chamber and is compressed further by the second stage, and so on. This is the same sequential compression process that happens in a turbojet's turbo compressor subsystem. For example, a six stage compressor as shown here, with a compression ratio of 1.4:1 per stage, would have an overall compression ratio of 7.5:1. Four more stages would bring that up to 28:1.

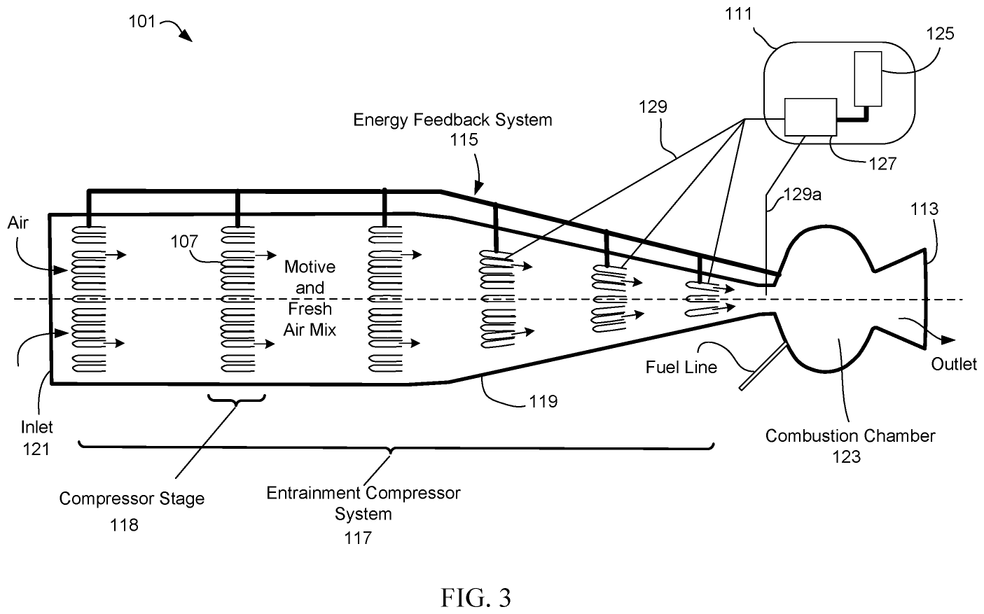

Referring now also to FIG. 4 in the drawings, a front view of system 117 is provided. As seen in FIG. 3, six (6) consecutive compressor stages comprising many nozzles 107 were arranged into nested circular arrays called compression stages. In FIG. 4, this view makes the smaller circular arrays nested within the larger arrays more apparent. In many actual designs, the density of nozzles will probably be higher than suggested here. Also, the nozzles 107 may be larger or smaller relative to the large ductwork than suggested here.

It is understood that nozzles 107 are oriented to direct the discharge of motive fluid downstream toward combustion chamber 123. It should also be understood that other arrangements of nozzles 107 are possible since there are no moving parts, such as vanes. This permits great design flexibility.

Referring back to FIG. 3, feedback system 115 is configured to include piping and valves necessary to regulate the passage of motive fluid from combustion chamber 123 to nozzles 107. Valves may be located at each branch of pipes within system 115. For example, a valve may be associated with each compressor stage 118. Any number of valves may be used. Each valve is in communication with controller 103.

These figures do not show the intricate details of the energy feedback subsystem 115 (tubing and valves) that provides and controls the flow of motive fluid to each nozzle 107. Nor do does it show the mechanical supports needed to hold the nozzles 107 and the energy feedback tubing rigidly in place. In many actual designs these tubing and support structures are likely to be combined.

System 101 also include an ignition system 111. Ignition system 111 is configured to assist in startup procedures by generating compressed motive fluid for injection into nozzles 107. System 111 may include a start/idle compressor 125 and a combustion chamber 127. The combustion chamber 127 is where an initial motive fluid is produced, typically prior to entrainment compressor system 117 being started. This motive fluid is injected through pipes 129 into nozzles 107.

Other embodiments of an entrainment compressed jet engine 101 are possible. For example, housing 119 may include a non-circular cross section. Any and all of the tubing used to transfer fluids may be of any cross section shape. The non-circular ductwork can be used for all but the high temperature/high pressure combustion chamber typically.

Compressors and combustion chambers can be connected by short or long pipes, and located far apart from each other if needed. A single compressor can feed several combustion chambers or conversely, several compressors can feed one combustion chamber. Likewise, multiple compressors (of similar or various size) can feed multiple combustion chambers (of similar or various size)

It is further understood that fuel system 109 may be coupled to at least one nozzle 107. This allows (suitably modified) nozzle 107 to ignite or have some degree of combustion. If a smaller fraction of the combustion gasses are used by the energy feedback system 115, the reduced energy could be replaced by introducing fuel into some or all of the (suitably modified) nozzles 107 and burning it there.

Although fuel is described primarily for combustion, all of the energy feedback system 115 as herein described could be replaced with a steam based system that uses heat energy from the main combustion chamber for all but start and idle operations. Once heat is available from the main combustion chamber, that energy could be used to produce the steam needed to maintain engine operation. An advantage of incorporating steam is that water is less expensive than jet fuel. Storage tanks may be used separately for water if steam functions are incorporated. Extra equipment and water storage tanks may reduce or cancel the advantages.

As alluded to above, there are different modes of operation for system 101. Two primary modes are that of startup and normal operation. Ignition system 111 is used here to initiate the flow of motive fluid when changing from a state of no activity to a state of some activity. There is a minimum rate of flow of the motive fluid in an entrainment jet engine to achieve stable steady state idle power, similar to the minimum rotation speed needed for idle in conventional turbojet engines. In the case of the turbojet engine, some aircraft rely on an external auxiliary power unit (APU) for the energy needed to initiate rotation and achieve idle. Other aircraft have an on-board system (e.g. an air turbine starter, ATS) for this function. The startup system 111 provides a similar function for the present invention.

Once idle has been achieved, the system 111 for the entrainment jet engine can be left running during normal operation or may be selectively shut down as the regular operative flow of motive fluid is sufficient to maintain operation. However, by keeping it operative to use in combination with feedback system 115, an ever present minimum flow rate for the motive fluid would be available as a safety precautions. This could allow rapid restart should it ever be needed.

Ignition system 111 (used for start-up) can be designed to generate up to several times the minimum motive fluid flow needed to do its job, using only the air from the start/idle compressor 125. A safety margin. When progressing from no activity to steady state idle power, the pilot adjusts the flight controls 102 in the proper sequence for engine start and idle. Controller 103 adjusts any variable geometry parts. Compressor 125 feeds air into the start/idle combustion chamber 127. Fuel is added to the start/idle combustion chamber 127, ignited, and motive fluid begins flowing in the start/idle energy feedback system via pipes 129. Air is entrained in the compressor system 117 and flows through it toward the compressor exit. Most of this flow recirculates to the start/idle combustion chamber in the start/idle system via tubing 129a. Some passes into the main combustion chamber 123 and exits via the exhaust nozzle 113. Generally, no fuel is added to the main combustion chamber at or below idle power, however some fuel may be introduced to warm up the engine 101. When the minimum required flow of motive fluid for steady state idle is reached the start/idle compressor 125 can shut down. The engine is now running at idle

During normal operating conditions power may be increased or decreased as needed. To increase power, controller 103 is configured to adjust one or more motive fluid valves to increase the flow rate of motive fluid through housing 119. Controller 103 may also increase the flow of fuel in chamber 123 or provide fuel flow to selected nozzles 107. To decrease power, the opposite is true. Controller 103 is configured to adjust one or more motive fluid valves to decrease the flow rate of motive fluid through housing 119. Controller 103 may also decrease the flow of fuel in chamber 123 or cease any or all fuel flow to selected nozzles 107.

There are many advantages and possible embodiments of system 101 and the description and Figures are not meant to be limiting. Such advantages include: (1) No moving parts excepting minor systems such as fuel pumps and duct/nozzle geometry adjustment parts; (2) No precision machined parts such as rotor blades and stator vanes; (3) Higher operating temperature due to no rotating parts; (4) Multiple operating modes in a single device, such as sub sonic and supersonic, or supersonic and hyper sonic, or hypersonic and sub orbital, or perhaps even all of the above, are possible; and (5) Hybrid variants are possible, using an exhaust turbine subsystem to create shaft horsepower rather than thrust, as the engine's primary output.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A jet engine, comprising:
an entrainment compressor system configured to compress air within a housing;
a combustion chamber in fluid communication with the entrainment compressor system, the combustion chamber configured to receive the compressed air and fuel and ignite the compressed air;
an exhaust nozzle coupled to the combustion chamber opposite the entrainment compressor system, wherein the air is routed to pass from the entrainment compressor system through the exhaust nozzle in order to generate thrust;
an energy feedback system configured to route a portion of motive fluid or exhaust gas from the combustion chamber to the housing; and
a nozzle configured to receive the air from the energy feedback system, the air acting as motive fluid to mix with new air and compress the mixed air into the combustion chamber.

2. The system of claim 1, further comprising:
an ignition system configured to compress and ignite a mixture of air and fuel to generate initial motive fluid, the initial motive fluid being directed through the nozzle to initiate a compression cycle within the entrainment compressor system.

3. The system of claim 2, wherein the ignition system provides a minimum flow rate of motive fluid during operation of the energy feedback system.

4. The system of claim 1, further comprising:
a controller configured to regulate the performance of the entrainment compressor system, energy feedback system, and nozzle, the controller receiving commands from flight controls and processing them to transmit data to the entrainment compressor system, energy feedback system, and nozzle.

5. The system of claim 1, wherein the nozzle is coupled to a fuel system and is configured to combust an air/fuel mixture.

6. The system of claim 1, wherein w/in the housing of the entrainment compressor system is void of vanes and mechanically rotating compression devices.

7. The system of claim 1, wherein the energy feedback system includes one or more valves operable via a controller, the controller configured to regulate the flow rate of motive fluid to the nozzle.

8. The system of claim 1, further comprising: a controller in communication with a sensor, the controller configured to monitor the performance of the jet engine.

9. The system of claim 1, wherein energy is generated without the need of drive shafts, bearings and other mechanically rotating devices.

10. A jet engine, comprising:
one or more entrainment compressor systems;
one or more combustion chambers;
one or more exhaust nozzles;
one or more energy feedback/motive fluid systems;
one or more energy feedback/motive fluid start up systems; and
one or more controller systems.

11. The engine of claim 10, wherein an entrainment compressor system is comprised of:
a housing;
an entrainment compressor within the housing;
one or more arrays of entrainment nozzles with one or more entrainment nozzles;
a tubing and valve network configured to convey motive fluid to a motive fluid input of each entrainment nozzle; and
a network of mechanical support structures configured to hold the one or more entrainment nozzles and the tubing and valve network in place within the housing; and
a combustion chamber is in fluid communication with the entrainment compressor;
wherein at least one exhaust nozzle is in fluid communication with the combustion chamber; and
wherein the energy feedback/motive fluid system is comprised of a network of tubing and valves configured to convey exhaust gasses from the combustion chamber to the entrainment compressor.

12. The engine of claim 11, wherein the one or more entrainment nozzles are tubes or pipes configured such that one end is an inlet for the motive fluid while the other end is an outlet for the motive fluid, and a longitudinal cross-section of the one or more entrainment nozzles has a cross section profile from input to output that is converging first then diverging;
wherein the entrainment nozzle is further configured so that it may have more than one motive fluid inlet and more than one motive fluid outlet.

13. The engine of claim 12, wherein the energy feedback/motive fluid system is in fluid communication with the combustion chamber;
wherein the tubing and valve network of the entrainment compressor is configured to pass through the housing of the entrainment compressor system; and
wherein the tubing and valve network of the entrainment compressor is in fluid communication with the tubing and valve network of the energy feedback/motive fluid system.

14. The engine of claim 13, further comprising:
an energy feedback/motive fluid start up system, the energy feedback/motive fluid start up system includes:
a conventional motor driven compressor; and
an entrainment/combustion nozzle.

15. The engine of claim 14, wherein the entrainment/combustion nozzle is an entrainment nozzle configured with a combustion chamber and is further configured to be in fluid communication with a fuel system.

16. The system of claim 15, further comprising:
a controller system in communication with various operator controls, sensors and activators associated with the engine, the control system is further configured to monitor various control and sensor inputs and adjust the various activator outputs to allow the engine to be started, operate at idle, accelerate and decelerate to one or more higher speeds, operate at those speeds for some time, decelerate idle and then be stopped.
